(19) United States
(12) Patent Application Publication
(10) Pub. No.: US 2024/0006706 A1
(43) Pub. Date: Jan. 4, 2024

(54) BATTERY MODULE FOR PREVENTING THERMAL RUNAWAY PROPAGATION

(71) Applicant: SK On Co., Ltd., Seoul (KR)

(72) Inventors: Jeong Woo HAN, Daejeon (KR); Hae Ryong JEON, Daejeon (KR)

(21) Appl. No.: 18/174,656

(22) Filed: Feb. 27, 2023

(30) Foreign Application Priority Data
May 17, 2022 (KR) 10-2022-0059943

(51) Int. Cl. H01M 50/325; H01M 50/375; H01M 50/505; H01M 50/148; H01M 50/143

(52) U.S. Cl. CPC H01M 50/325; H01M 50/375; H01M 50/143; H01M 50/148; H01M 50/505

(57) ABSTRACT

Provided is a battery module including a battery cell stack and a module housing accommodating the battery cell stack, wherein the module housing includes: a lower housing supporting a lower surface and both side surfaces of the battery cell stack; as upper plate disposed on an upper surface of the battery cell stack and coupled to the lower housing; and a first cover plate disposed on a front surface of the battery cell stack and a second cover plate disposed on a rear surface of the battery cell stack, each of the first cover plate and the second cover plate is coupled. to the lower housing, each of the first cover plate and the second cover plate includes a plurality of vent holes, and the vent holes included in the first cover plate are misaligned with the vent holes included in the second cover plate.

### CROSS-REFERENCE TO RELATED APPLICATIONS

This application claims priority under 35 U.S.C. §119 to Korean Patent Application No. 10-2022-0059943, filed on May 17, 2022, in the Korean Intellectual Property Office, the disclosure of which is incorporated herein by reference in its entirety.

### TECHNICAL FIELD

The following disclosure relates to a battery module capable of minimizing damage resulting from thermal runaway of the battery module.

### BACKGROUND

Secondary batteries are widely applied to not only portable devices but also electric vehicles (EVs) or hybrid electric vehicles (HEVs) driven by electric drive sources, because the secondary batteries are easy to apply according to product groups and have excellent electrical characteristics such as high energy density. These secondary batteries are being spotlighted as a new energy source for improving eco-friendliness and energy efficiency in that the secondary batteries are not only capable of dramatically reducing the use of fossil fuels as a primary advantage but also generate no by-products after the use of energy.

Types of secondary batteries that are currently in wide use include lithium ion batteries, lithium polymer batteries, nickel cadmium batteries, nickel hydride batteries, nickel zinc batteries, and the like. A secondary battery may be used by connecting a plurality of battery cells to each other in series or in parallel, and the number of battery cells may be variously set according to a required output voltage or a required charge/discharge capacity.

A battery module including one or more battery cells may be formed first, and one or more battery modules may be stacked for use as a large-capacity battery for an electric vehicle or the like.

Meanwhile, since the secondary battery has a risk of explosion. when overheated, it is one of the important tasks to secure safety. When heat is abnormally generated. in the secondary battery, an internal temperature of the secondary battery rapidly rises, and a thermal runaway phenomenon occurs in the secondary battery, eventually leading to explosion of the secondary battery. Even in a case where heat is abnormally generated due to a short circuit inside a cell, overcharging, physical external shock, or the like, as well as the overcurrent, this leads to explosion or ignition of the secondary battery and there is a risk of a fire accident. Therefore, it is required to strictly manage the secondary battery.

In particular, a safety issue of a battery module is more serious. If high-temperature gas/particles generated due to abnormal heat generation from the battery cell inside the module fail to escape out of the module, a pressure inside the module rises, and the thermal runaway of the battery cell leads to explosion of all battery modules, causing great damage.

Conventionally, a battery module has a vent hole structure to discharge high temperature gas/particles generated by thermal runaway. However, in a case where a plurality of battery modules are used for designing a large capacity battery, there is a problem that high-temperature gas/particles discharged from vent holes of one of the battery modules flow into vent holes of the adjacent module, thereby propagating a thermal runaway phenomenon. In addition, in a case where a battery module has a structure in which vent holes are opened, external moisture or foreign substances penetrate into the battery module through the vent holes in a normal operating environment, causing a short circuit, and as a result, explosion occurs.

Therefore, there is a need for a technology capable of effectively discharging high-temperature gas/particles when a thermal runaway phenomenon occurs in a battery module, while minimizing damage to an adjacent module and preventing the inflow of eternal moisture or foreign substances.

### SUMMARY

An embodiment of the present invention is directed to providing a battery module capable of effectively discharging high-temperature gas/particles when a thermal runaway phenomenon occurs in the battery module while minimizing damage to an adjacent module.

Another embodiment of the present invention is directed to providing a battery module capable of preventing the inflow of external moisture or foreign substances while effectively discharging high-temperature gas/particles when a thermal runaway phenomenon occurs.

In one general aspect, a battery module includes a battery cell stack 110 and a module housing accommodating the battery cell stack 110, wherein the module housing includes: a lower housing supporting a lower surface and both side surfaces of the battery cell stack 110; an upper plate 170 disposed on an upper surface of the battery cell stack 110 and coupled to the lower housing; and a first cover plate disposed on a front surface of the battery cell stack 110 and a. second cover plate disposed on. a rear surface of the battery cell stack 110, each of the first cover plate and the second cover plate is coupled to the lower housing, each of the first cover plate and the second cover plate includes a plurality of vent holes 200, and the vent holes included in the first cover plate are misaligned with the vent holes included in the second cover plate.

Each of the first cover plate and the second cover plate may further include a venting sheet 300 covering the vent holes 200.

The venting sheet 300 may include a base layer 310 and an adhesive layer 320 formed on at least one surface of the base layer 310, and the adhesive layer 320 may include holes having the same shape as the vent holes 200 of the first cover plate or the second cover plate to correspond thereto.

The base layer 310 may be deformed at a critical temperature to open the vent holes 200.

The critical temperature may be 100 to 400° C.

The base layer 310 may have a waterproof level of IP11 or more according to IEC60529 standards.

The base layer 310 may be a porous layer.

The vent holes 200 of the first cover plate may be spaced apart from each other through separation regions, and the vent holes 200 of the second cover plate may be located in the separation regions.

The vent holes 200 of the first cover plate may have a different size from the vent holes 200 of the second cover plate.

The battery module may further include a guide part coupled to an opening of each vent hole 200 of the first cover plate or the second cover plate to guide gas discharged from the inside of the module through the vent hole 200 to the outside of the module.

The guide part may be coupled at an angle different from a normal direction of an outer side surface of the first cover plate or the second cover plate.

The battery module may further include a bus bar assembly 140 between the battery cell stack 110 and the first cover plate or the second cover plate.

The bus bar assembly 140 may include vent holes 200 having the same shape as the vent holes 200 of the first cover plate or the second cover plate to correspond thereto.

The battery module may further include a venting sheet 300 covering the vent holes between the bus bar assembly 140 and the first cover plate or the second cover plate.

The battery module according to the present disclosure is capable of effectively discharging high-temperature gas/particles when a thermal runaway phenomenon occurs in the battery module while minimizing damage to an adjacent module.

The battery module according to the present disclosure is also capable of preventing the inflow of external moisture or foreign substances into the battery module while effectively discharging high-temperature gas/particles when a thermal runaway phenomenon occurs.

### BRIEF DESCRIPTION OF THE DRAWINGS

FIG. 1 illustrates an exploded perspective view of a battery module according to the present disclosure.

FIG. 2 illustrates an embodiment of a battery module according to the present disclosure in which vent holes included in a first cover plate are misaligned with vent holes included in a second cover plate when a plurality of battery modules are disposed.

FIG. 3 illustrates a battery module including a venting sheet according to the present disclosure.

FIG. 4 illustrates a structure of the adhesive sheet according to the present disclosure.

### DETAILED DESCRIPTION OF MAIN ELEMENTS

110: Battery cell stack
120: Cover plate
130: Insulating plate
140: Bus bar assembly
155: Partition wall member
160: Lower plate
165: Side plate
170: Upper plate
200: Vent hole
300: denting sheet
310: Base layer
320: Adhesive layer
330: Hole formed in adhesive layer

### DETAILED DESCRIPTION OF EMBODIMENTS

Singular forms of terms used herein may be interpreted as including plural forms unless otherwise indicated.

The numerical range used herein includes all values within the range including the lower limit and the upper limit, all double limited values, and all possible combinations of the upper limit and the lower limit in the numerical range defined in different forms. Unless otherwise specifically defined herein, values outside the numerical range that may occur due to experimental errors or by rounding values are also included in the defined numerical range.

The expression “include” used herein is an open-ended expression having a meaning equivalent to the expression “provide”, “contain”, “have”, “is/are characterized”, or the like, and does not exclude additional elements, materials or processes which are not enumerated.

The expression “cover plate 120” mentioned without any modification refers to both the first cover plate and the second cover plate.

The expression “critical temperature” mentioned herein. refers to a temperature at which a rapid shape deformation occurs in a base layer 310, and may refer to, for example, a melting point or a thermal deformation. temperature.

Conventionally, a battery module has vent holes 200 to discharge high-temperature gas particles generated by thermal runaway. However, in a case where a large-capacity battery in which a plurality of battery modules are stacked is used in the industrial field related to electric vehicle, aircraft, or the like, there is a problem that high-temperature gas/particles discharged from vent holes 200 of one of the battery modules flow into vent holes 200 of the adjacent module, thereby propagating a thermal runaway phenomenon. In addition, external moisture or foreign substances penetrate into the battery module through the vent holes 200 in a normal operating environment, causing a short circuit, and as a result, a fire occurs. Therefore, there is a need for a technology capable of effectively discharging high-temperature gas/particles when a thermal runaway phenomenon occurs in a battery module, while minimizing damage to an adjacent module and preventing the inflow of external moisture or foreign substances.

To this end, the present disclosure provides a battery module including a battery cell stack 110 and a module housing accommodating the battery cell stack 110, wherein the module housing includes: a lower housing supporting a lower surface and both side surfaces of the battery cell stack 110; an upper plate 170 disposed on an. upper surface of the battery cell stack 110 and coupled to the lower housing; and a first cover plate disposed on a front surface of the battery cell stack 110 and a second cover plate disposed on a rear surface of the battery cell stack 110, each of the first cover plate and the second cover plate is coupled to the lower housing, each of the first cover plate and the second cover plate includes a plurality of vent holes 200, and the vent holes 200 included in the first cover plate are misaligned with the vent holes 200 included in the second cover plate.

The plurality of vent holes 200 included in the first cover plate and the second cover plate are provided to adjust a pressure in the battery module. When high-temperature gas is generated according to a thermal runaway phenomenon, the gas inside the module can be discharged to the outside of the module through the vent holes 200.

The expression “misaligned with each other” described. above means that vent holes 200 are not located in a region of the second cover plate corresponding to an opening region where the vent holes 200 of the first cover plate are disposed in a normal direction of a surface of the first cover plate or the second cover plate. By locating the vent holes 200 included in the first cover plate to be misaligned with the vent holes 200 included in the second cover plate, when thermal runaway occurs, high-temperature gas/particles are suppressed from flowing shortly into an adjacent battery module, thereby effectively preventing propagation of thermal runaway or a chain of explosions.

A battery module according to the present disclosure will be described in more detail below.

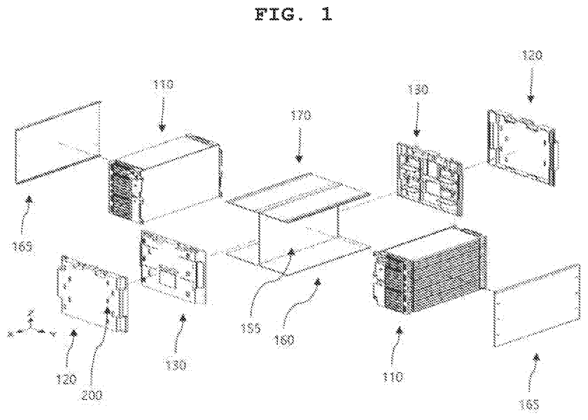

Referring to FIG. 1, the battery module includes a module housing, and a battery cell stack 110 is accommodated in an internal space of the module housing. By disposing the battery cell stack 110 in. the module housing, the battery cell stack 110 can be protected from the external environment, and a plate on one side constituting the module housing may function as a heat dissipation plate that dissipates heat generated from battery cells to the outside. The battery cell stack 110 will be described. in detail later in this specification.

The module housing may include: a lower housing supporting a lower surface and both side surfaces of the battery cell stack 110; an upper plate 170 disposed on an upper surface of the battery cell stack 110 and coupled to the lower housing; and a first cover plate disposed on a front surface of the battery cell stack 110 and a second cover plate disposed on a rear surface of the battery cell stack 110, and each of the first cover plate and the second cover plate may be coupled to the lower housing.

The lower housing may include a lower plate 160 and side plates 165. The lower plate 160 and the side plates 165 may be each independently included in the module housing, or may be included in the module housing in a joined state in a form having a U-shaped cross section. If necessary, in order to firmly support the battery cell stack 110, the side plates 165 may be configured to directly contact the battery cell stack 110. If necessary, various modifications may be made, such as interposing a heat dissipation pad, a buffer pad, or the like between the side plates 165 and the battery cell stack 110.

The upper plate 170 is disposed on the upper surface of the battery cell stack 110, and may be coupled to the side plates 165 of the lower housing. When the lower housing and the upper plate 170 are coupled, the module housing may have a shape like a hollow tubular member as a whole

The module housing may include a partition wall member 155 disposed across the internal space formed in the module housing to connect the lower plate 160 and the upper plate 170 to each other. As illustrated in FIG. 1, a plurality of battery cells may be stacked between the partition wall member 155 and the side plates 165.

The partition. wall member 155 is disposed in a vertical direction inside the module housing to resist external factors in the vertical direction. In this manner, the partition wall member 155 increases the overall rigidity of the module housing, thereby reducing damage to the battery module due to mechanical external factors such as crushing, crashing, vibration, and shock according to the present embodiment. As illustrated in FIG. 1, the partition wall member 155 may be fixed to the upper plate 170 and the lower plate 160.

The first cover plate and the second cover plate cover may be coupled to the lower housing from the front and rear surfaces of the battery cell stack 110, respectively, in a direction along opposite ends to cover the internal space of the hollow tubular member formed by coupling the lower housing and the upper plate 170 to each other.

The lower housing, the upper plate 170, and/or the cover plates 120 may be made of a material having high thermal conductivity such as metal. For example, the lower housing, the upper plate 170, and/or the cover plates 120 may be made of aluminum, and various materials may be used as long as they have strength and thermal conductivity similar to those of aluminum.

The lower housing, the upper plate 170, and/or the cover plates 120 may be coupled to each other by welding contact surfaces thereof, for example, by performing laser welding or the like. Alternatively, the lower housing, the upper plate 170, and/or the cover plates 120 may be coupled to each other by a sliding manner or in a bonded manner, or may be coupled to each other using a fixing member such as a bolt or a screw.

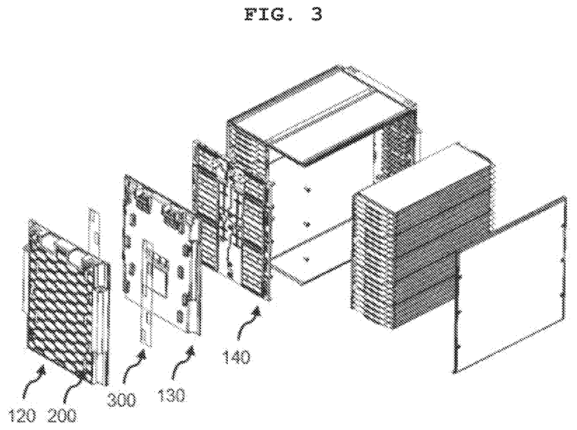

In an embodiment, the first cover plate or the second cover plate may include a venting sheet 300 covering the vent holes 200. The venting sheet 300, which is a venting sheet 300 that satisfies both the air permeability and the waterproof level and has a predetermined heat resistance characteristic at a critical temperature or less, may be located at a portion corresponding to the vent holes 200 as illustrated in FIG. 3. By providing the venting sheet 300, it is possible to prevent penetration of external moisture or foreign substances into the battery module, which causes an occurrence of a short circuit, in a normal operating environment. Specifically, the venting sheet 300 may be provided on an inner side surface and/or an outer side surface of the first cover plate or the second cover plate. The venting sheet 300 may be in the form of a sheet, a film, or a tape, but this is only an example and the form of the venting sheet 300 is not limited thereto.

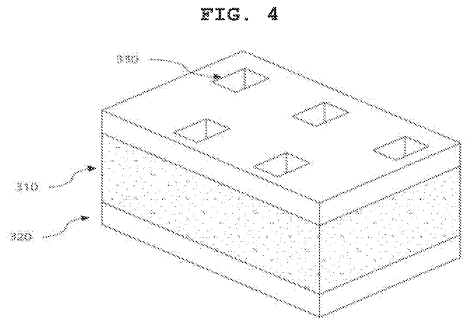

In an embodiment, the venting sheet 300 may include a base layer 310 and an adhesive layer 320 formed on at least one surface of the base layer 310, and the adhesive layer 320 may include holes 330 having the same shape as the vent holes 200 of the cover plate 120 to correspond thereto. The venting sheet 300 may be attached to the cover plate 120 through the adhesive layer 320. Referring to FIG. 4, since the adhesive layer 320 includes holes 330 having the same shape as the vent holes 200 formed in the cover plate 120 to correspond thereto, when the venting sheet 300 is attached to the cover plate 120, the adhesive layer 320 does not exist in portions corresponding to areas of the vent holes 200. Therefore, the vent holes 200 are riot sealed with the adhesive layer 320, and the adhesive layer 320 is attached to the cover plate 120 only in an area other than the vent holes 200. Accordingly, it is possible to prevent external foreign substances or moisture introduced through the vent holes 200 from being attached. to the adhesive layer 320, such that the adhesive layer 320 is not contaminated, and. the adhesive force of the adhesive layer 320 is maintained, resulting in a long-term stability effect. In addition, by exposing only the base layer 310 in the portions corresponding to the vent holes 200, the base layer 310 is deformed. at the critical temperature or more when a thermal runaway phenomenon occurs, such that the vent holes 200 are quickly opened to effectively discharge gas inside the module to the outside. As a material constituting the adhesive layer 320 to do so, an acryl-based material, a rubber-based material, or a silicone-based material may be used.

In an embodiment, the base layer 310 may be deformed at the critical temperature to open the vent holes 200. The deformation encompasses any of an aspect in which the base layer 310 is melted at a melting point, an aspect in which the base layer 310 is burned and its initial shape is lost, and an aspect in. which the base layer 310 shrinks and its cross-sectional area decreases, and is not limited thereto as long as the deformation of the base layer 310 is capable of opening the vent holes 200. Accordingly, when a thermal runaway phenomenon occurs, the base layer 310 is deformed at the critical temperature or more to open the vent holes 200 and discharge high-temperature gas, thereby improving the operational stability of the battery module.

In an embodiment, the critical temperature may be 100 to 400° C. Since the base layer 310 has a critical temperature with respect to its material, the shape of the base layer 310 can be rapidly deformed about the critical temperature to open the vent holes 200 as described. above. A normal operating temperature of the battery module is 100° C. or less, and an initial temperature of thermal runaway gas is usually about 100 to 200° C., that is, the thermal runaway gas is a high-temperature gas. If the base layer 310 is not deformed at the critical temperature or more, an internal pressure of the module may continuously rise as a thermal runaway phenomenon continues, causing a chain of explosions of battery modules or battery packs. By forming the base layer 310 using a material that is deformed at the critical temperature, it is possible to prevent in advance a problem that the battery module explodes due to a rise in pressure and manage the module more safely. Particularly, the critical temperature may be 150 to 400° C., more particularly 200 to 350° C. As a material constituting the base layer 310, a material having the critical temperature may be used. For example, the material constituting the base layer 310 may be synthetic resin or rubber, and particularly, polyethylene, polyethylene terephthalate, polytetrafluoroethylene, polypropylene, or rubber. More particularly, the material constituting the base layer 310 may be polytetrafluoroethylene in terms of thermal deformation temperature, but is not necessarily limited thereto.

That is, in the battery module according to the present disclosure, by locating the vent holes 200 included in the first cover plate to be misaligned with the vent holes 200 included in the second cover plate, it is possible to prevent a thermal runaway phenomenon from propagating into an adjacent module due to high-temperature gas/particles flowing thereinto. In addition, in a normal operating environment, external moisture or foreign substances can be prevented from penetrating into the module and causing a short circuit by the venting sheet 300 covering the vent holes 200, and also, foreign substances or moisture can be prevented from being attached to the adhesive layer 320 because no adhesive layer 320 exists in the areas of the vent holes 200, thereby preventing the venting sheet 300 from contaminated or from deteriorating in adhesive force in addition, by exposing only the base layer 310 in the portions corresponding to the vent holes 200, the base layer 310 can be deformed at the critical temperature or more when a thermal runaway phenomenon occurs, such that the vent holes 200 are quickly opened to effectively discharge gas inside the module to the outside.

In an embodiment, the base layer 310 may have a waterproof level of IP11 or more according to IEC60529 standards. By using the base layer 310 haying a waterproof level that satisfies the above-described level, it is possible to effectively prevent external moisture from being introduced into the module and causing corrosion or short circuiting in the normal operating environment. The waterproof level may be IP15 or less, but is not limited thereto.

In an embodiment, the base layer 310 may be a porous layer. Air permeability may be implemented by forming microporous holes by stretching the material having a waterproof level of IP11 or more, or by a method similar thereto. When the gas permeability satisfies the above-described range, circulation of air and ventilation between the inside and the outside of the module effectively occur even in the normal operating environment. As the base layer 310 satisfies both the air permeability and the waterproof level, air can pass through the microporous holes in the normal operating environment while passage of moisture is suppressed, thereby effectively improving the stability of the battery module. The gas permeability of the base layer may be 600 to 1000 ml/min.

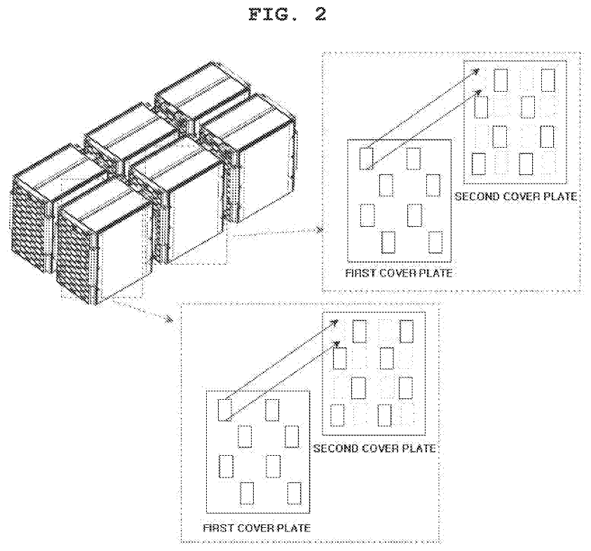

In an embodiment, the vent holes 200 of the first cover plate may be spaced apart from each other through separation regions, and the vent holes 200 of the second cover plate may be located in the separation regions. Referring to FIG. 2, when the first cover plate and the second cover plate overlap each other in a normal direction of a surface of the first cover plate, the vent holes 200 of the first cover plate are spaced apart from. each other through the separation regions, and no vent holes 200 exist in the second cover plate corresponding to the opening regions. That is, the vent holes 200 may be located in the second cover plate to correspond to the separation regions so as to be misaligned from the vent holes 200 located in the first cover plate.

In another embodiment, the vent holes 200 of the first cover plate may be located only within a distance of ⅓ from an upper end of the cover plate 120, and the other vent holes 200 may be located only within a distance of ⅓ from a lower end. of the second. cover plate, such that the vent holes 200 of the first cover plate are misaligned with the vent holes 200 of the second cover plate. By designing the vent holes 200 of the first cover plate and the vent holes 200 of the second cover plate to be misaligned with each other and formed to be different in location from each other as described above, when a thermal runaway phenomenon occurs, high-temperature gas/particles can be prevented from immediately flowing into an adjacent battery module, thereby effectively preventing propagation of thermal runaway or a chain of explosions.

In an embodiment, the vent holes 200 of the first cover plate may have a different size from the vent holes 200 of the second cover plate. When the vent holes 200 of the first over: plate and the vent holes 200 of the second cover plate are located to be misaligned with each other as described above, its effect of preventing inflow of high-temperature gas/particies can be maximized by designing the vent holes 200 of the first cover plate and the vent holes 200 of the second cover plate to have different sizes. For example, in a case where the vent holes 200 have a rectangular shape, the first cover plate may be designed to have vent holes 200 of which sizes are divided into two ranges, one range being from 1 to 5 cm and the other range being from 6 to 10 cm, and the second cover plate corresponding to the first cover plate may be designed to have vent holes 200 of which sizes are divided. into two ranges, one range being from 6 to 10 cm and the other range being from 1 to 5 cm, such that the sizes of the corresponding vent holes 200 are different. Since each of the vent holes 200 has a different size, it is possible to more effectively prevent high-temperature gas/particles from flowing into an adjacent module through the vent holes 200 of the module and suppress a thermal runaway propagation phenomenon. When the sizes of the vent holes 200 are divided into the two ranges as described above, the ratio may be 3:7 to 7:3.

The shape of the vent holes 200 is not particularly limited, and the vent holes 200 may exist in various shapes.

For example, in a case where the vent holes 200 are provided in a rectangular shape, the vent holes 200 may have a size of 1 to 10 cm in a case where the vent holes 200 are provided in an oval shape with a horizontal length being larger than a vertical length, the vent holes 200 may have a horizontal diameter of 1 to 10 cm and a vertical diameter of 1 to 3 cm. The locations of the vent holes 200 are not particularly limited, and the vent holes 200 may exist in the cover plates 120 at locations where high-temperature gas/particies can be effectively discharged. For example, the vent holes 200 may be located throughout the entire portion of the cover plate 120, or may be located within a predetermined distance from both ends of the cover plate 120 in the vertical direction or within a predetermined distance from both ends of the cover plate 120 in the horizontal direction. On the premise that the vent holes 200 of the first cover plate and the vent holes 200 of the second cover plate are located to be misaligned with each other in order to suppress a thermal runaway propagation phenomenon as described above, the effect can be maximized by designing the vent holes 200 of the first cover plate and the vent holes 200 of the second. cover plate to have different sizes. The vent holes 200 of the first cover plate and the vent holes 200 of the second cover plate may be spaced apart from each other by the same separation regions in both the horizontal and vertical directions, or may be spaced apart from each other by different separation regions. The size of the separation regions for spacing the vent holes apart from each other is not particularly limited, but may be, for example, 0.1 to 1 cm in a case where the vent holes 200 of the first cover plate and the vent holes 200 of the second cover plate are spaced apart from each other by the same separation regions in both the horizontal and vertical directions, and 0.1 mm to 0.3 in the horizontal direction and 0.5 to 0.8 mm in the vertical direction in a case where the vent holes 200 of the first cover plate and the vent holes 200 of the second cover plate are spaced apart from each other by different separation regions.

In an embodiment, the battery module may further include a guide part coupled to an opening of the vent hole 200 of the first cover plate or the second cover plate to guide gas discharged from the inside of the module through the vent hole 200 to the outside of the module. The outside refers to the outside of the module housing, and for example, may refer to a direction toward a corner based on the cross section of the cover plate 120. By attaching the guide part to the opening of the vent hole 200 of the cover plate 120 to guide the flow of high-temperature gas/particles passing through the vent hole 200 from the inside of the module to the outside of the module, it is possible to more effectively suppress the flow of the high-temperature gas/particles into an adjacent battery module.

In an embodiment, the guide part may be coupled at an angle different from a normal direction of the outer side surface of the first cover plate or the second cover plate. By adjusting the angle at which the guide part is coupled to an angle different from the normal direction, high-temperature gas/particles passing through the vent hole 200 from the inside of the module are prevented from flowing through a vent hole 200 of an adjacent battery module, and can be effectively guided to the outside of the module. The guide part may communicate with the opening of the vent hole 200 through a connection part coupled to the opening of the vent hole 200. The guide part may be coupled with a distal end thereof forming an angle of 10 to 90°, particularly 20 to 80°, with respect to the normal direction of the outer side surface of the first cover plate or the second cover plate.

The guide part may have any shape without limitation as long as it is capable of guiding the flow of gas/particles to the outside of the module. For example, a guide part having a shape like a hollow pipe may be attached to a boundary surface of each of the vent holes 200 of the cover plates 120 to guide the flow of high-temperature gas/particies to the outside of the stacked battery modules.

The battery cell stack 110 may be formed by stacking a plurality of battery cells.

The battery cells may include pouch-type secondary batteries, prismatic secondary batteries, or cylindrical secondary batteries, or may include secondary batteries commonly used in the related art. In an embodiment of the present disclosure, a pouch type secondary battery will be described.

The battery cells may be configured in such a manner that one or more pouch-type secondary batteries are stacked, each of the pouch-type secondary batteries having an electrode assembly and an electrolyte accommodated therein. The electrode assembly including a plurality of electrode plates and a plurality of electrode tabs is accommodated in a pouch. The electrode plates include positive electrode plates and negative electrode plates, and the electrode assembly may be configured in such a manner that a positive electrode plate and a negative electrode plate are stacked with a separator interposed therebetween in a state where wide surfaces of the positive electrode plate and. the negative electrode plate face each other. The plurality of positive electrode plates and negative electrode plates include respective electrode tabs, which may be connected to the same electrode lead by contacting each other with the same polarity, and a partial portion of the electrode lead may be exposed to the outside of the pouch.

In an embodiment, when using a long-width battery cell of which a horizontal length between both ends is much longer than a vertical length at one end, the battery cell may include a positive electrode lead and a negative electrode lead at one end, and a negative electrode lead and a positive electrode lead at the other end. The positive electrode leads and the negative electrode leads included in the one end and the other end of the battery cell may be disposed in reverse on the left and right sides, respectively. In this case, since current can flow through electrode leads located at a close distance from each other, an internal resistance of the battery cell can be minimized. The electrode leads of the battery cell are not necessarily limited thereto, and a positive electrode lead may be located at one end of the battery cell and a negative electrode lead may be located at the other end of the battery cell. Alternatively, a positive electrode lead and a negative electrode lead may be located only at one end of the battery cell. The locations of the positive and negative electrode leads may be appropriately modified as needed in the process of implementing the battery module.

The battery cell stack 110 may be formed. by stacking a plurality of battery cells in the vertical direction in. a state in which the battery cells are laid horizontal. The way in which the battery cell stack 110 is formed is not necessarily limited thereto, and the battery cell stack 110 may be formed by stacking a plurality of battery cells in a left-right direction or in a horizontal direction in a state where the battery cells are vertically erected. The way in which the battery cell stack 110 is formed may be appropriately modified as needed in the process of implementing the battery module.

In an embodiment, the battery cell may have a weaker sealing force on both end surfaces than on the other surfaces. The sealing force of the battery cell on both end surfaces, which face directions in which the electrode leads are located, may be weaker than that on the other surfaces, so that gas is discharged in directions towards the cover plates 120 when abnormal heat generation occurs in the battery cell. By directing the high-temperature gas generated from the battery cell toward the cover plates 120, in which the vent holes 200 are provided, the gas discharge effect. of the vent holes 200 can be further improved.

In an embodiment, the battery module may further include a bus bar assembly between the battery cell stack and the first cover plate or the second cover plate. Referring to FIG. 3, a bus bar assembly 140 may be interposed between the cover plate 120 and the battery cell stack 110, and may be located on one surface or both surfaces where the electrode leads of the battery cell are disposed. A plurality of electronic devices, such as a bus bar that electrically connects the plurality of battery cells to each other, a circuit board, and a sensor mounted on the circuit board, may be interposed in the bus bar assembly 140, to perform a function or sensing voltages of the battery cells. The battery module may be configured in various aspects. For example, the battery module may be formed by interposing the battery cell stack 110—the bus bar assembly 140—the insulating plate 130—the cover plate 120 in this order.

In an embodiment, the bus bar assembly may include vent holes having the same shape as the vent holes of the first cover plate or the second cover plate to correspond thereto. Through the vent holes 200, gas generated inside the module can be quickly discharged to the outside.

In an embodiment, the battery module may further include a venting sheet covering the vent holes between the bus bar assembly 140 and the first cover plate or the second cover plate. The above-described venting sheet 300 may also be attached to the bus bar assembly 140 to further improve the effect of preventing external moisture or foreign substances from penetrating into the battery module. As another example, the battery module may further include a venting sheet covering the vent holes between the insulating plate 130 and the first cover plate or the second cover plate.

The bus bar assembly 140 may have a separate through hole into which an electrode lead is inserted, and the electrode lead may penetrate through the bus bar assembly 140 and be connected to the bus bar assembly 140 from the outside of the bus bar assembly 140. The bus bar assembly 140 may include a connection terminal, and the electrode lead may be electrically connected to the outside through the connection. terminal. The cover plate 120 may have a through hole for exposing the connection terminal of the bus bar assembly 140 to the outside. The connection terminal is exposed to the outside through the through hole formed in the cover plate 120.

Hereinafter, the present disclosure will be described in detail through examples, but these examples are provided for more specific explanation, and the scope of rights is not limited by the following examples.

### Example 1

In order to evaluate a thermal runaway propagation. suppressing effect of a battery module according to an embodiment of the present disclosure, a battery module was prepared, in which square vent holes each having a size of 5 cm are formed at intervals of 1 cm in a first cover plate, and vent holes are disposed in a second cover plate to be misaligned with the vent holes of the first cover plate. The venting sheets 300 were attached to inner and outer side surfaces of each cover plate. As the venting sheet, a venting sheet 300 including a base layer 310 of polytetrafluoroethylene having a waterproof level of IP11 and a gas permeability of 850 mL/min and adhesive layers 320 formed on both sides of the base layer 310 was used. The adhesive layer 320 includes an acrylic adhesive, and holes identical to the vent holes were formed in the adhesive layer 320. In addition, referring to the GB/T-38031 test, which is one of the battery module safety tests, two other battery modules were placed adjacent to the battery module in a direction in which the cover plates 120 of the battery module faced each other, and a thermal runaway situation was deliberately simulated by heating a certain battery cell of one battery module to 300° C. or more.

### Example 2

A battery module having the same configuration as that in Example 1 was prepared, except that the vent holes 200 formed. in the first cover plate are designed to have two different sizes of 3 cm and 7 cm at a ratio of 50:50, and the vent holes 200 formed in the second cover plate, which correspond to the vent holes 200 formed in the first cover plate, are designed to have two different sizes of 7 cm and 3 cm at a ratio of 50:50 in a converse manner, such that the corresponding vent holes (200) formed in. the first cover plate and the second cover plate have converse sizes. Then, a thermal runaway situation was simulated.

### Example 3

A battery module having the same configuration as that in Example 1 was prepared, except that a guide part is coupled to an opening of the vent hole 200 formed in each of the cover plates 120. Then, a thermal runaway situation was simulated. Specifically, the guide part is an aluminum hollow circular rod-like pipe having a hollow of which a size is 5 cm at both ends thereof, and was bound to the opening of the vent hole 200 at an angle of 60° upward from the normal direction in which the battery modules were stacked.

### Example 4

A battery module having the same configuration as that in Example 1 was prepared, except that the venting sheets 300 were not attached to the inner and outer side surfaces of each cover plate. Then, a thermal runaway situation was simulated.

### Comparative Example 1

A battery module having the same configuration as that in Example 1 was prepared, except that the second cover plate is designed to have vent holes 200 in a region corresponding to an opening region where the vent holes 200 of the first cover plate are disposed. Then, a thermal runaway situation was simulated.

### Evaluation Example

While a thermal runaway phenomenon lasted for 1 hour, it was confirmed whether the thermal runaway phenomenon propagated to an adjacent battery module.

The battery module was operated for 5 minutes in a normal operating environment in which no thermal runaway or ignition occurred, and it was evaluated whether a short circuit occurred in the module.

TABLE 1

| | | Comparative |
|---|---|---|
| | Example 1 | Example 1 |
| Misaligned vent holes (200) | ◯ | X |
| Venting sheet (300) | ◯ | ◯ |
| Whether thermal runaway | X | ◯ |
| propagates | | |

In Examples 1 to 3, since the vent holes 200 of the first cover plate were misaligned with the vent holes 200 of the second cover plate, it was confirmed that even though the thermal runaway having occurred in one battery module lasted for 1 hour, the thermal runaway phenomenon did not propagate to an adjacent battery module.

In contrast, in Comparative Example 1, it was confirmed that when a thermal runaway phenomenon occurred in one battery module, the thermal runaway phenomenon propagated to an adjacent battery module within 5 minutes.

In addition, as a result of driving in a normal operating environment, it was confirmed that no short circuit occurred due to the existence of the venting sheet 300 in Examples 1 to 3.

In Example 4, even though a thermal runaway phenomenon occurred in one battery module, the thermal runaway phenomenon did not propagate to an adjacent battery module. However, it was confirmed that a large amount of foreign substances and moisture flowed into the module in a normal operating environment, which was not suitable for stably operating the battery module. In particular, it was confirmed that a short circuit occurred due to the inflow of the foreign substances.

Although the embodiments of the present disclosure have been described above, the present disclosure is not limited to the above-described embodiments, and may be embodied in various different forms. Those skilled in the art to which the present disclosure pertains will be able to understand that the present disclosure can be implemented in other specific forms without changing the technical spirit or essential features of the present invention. Therefore, it should be understood that the embodiments described above are exemplary in all respects and are not limiting.

What is claimed is:

1. A battery module comprising a battery cell stack and a module housing accommodating the battery cell stack, wherein the module housing includes:
a lower housing supporting a lower surface and both side surfaces of the battery cell stack;
an upper plate disposed. on an upper surface of the battery cell stack and coupled to the lower housing; and
a first cover plate disposed on a front surface of the battery cell stack and a second cover plate disposed on a rear surface of the battery cell stack,
each of the first cover plate and the second. cover plate is coupled to the lower housing,
each of the first cover plate and the second cover plate includes a plurality of vent holes, and
the vent holes included in the first cover plate are misaligned with the vent holes included in the second cover plate.

2. The battery module of claim 1, wherein each of the first cover plate and the second cover plate further includes a venting sheet covering the vent holes.

3. The battery module of claim 2, wherein the venting sheet includes a base layer and an adhesive layer formed on at least one surface of the base layer, and the adhesive layer includes holes having the same shape as the vent holes of the first cover plate and the second cover plate to correspond thereto.

4. The battery module of claim 3, wherein the base layer is deformed at a critical temperature to open the vent holes.

5. The battery module of claim 4, wherein the critical temperature is 100 to 400° C.

6. The battery module of claim 3, wherein the base layer has a waterproof level of IP11 or more according to IEC60529 standards.

7. The battery module of claim 3, wherein the base layer is a porous layer.

8. The battery module of claim 1, wherein the vent holes of the first cover plate are spaced apart from each other through separation regions, and the vent holes of the second cover plate are located in the separation regions.

9. The battery module of claim 1, wherein the vent holes of the first cover plate have a different size from the vent holes of the second cover plate.

10. The battery module of claim 1, further comprising a guide part coupled to an opening of each vent hole of the first cover plate or the second cover plate to guide gas discharged from the inside of the module through the vent hole to the outside of the module.

11. The battery module of claim 10, wherein the guide part is coupled at an angle different from a normal direction of an outer side surface of the first cover plate or the second cover plate.

12. The battery module of claim 1, further comprising a bus bar assembly between the battery cell stack and the first cover plate or the second cover plate.

13. The battery module of claim 12, wherein the bus bar assembly includes vent holes having the same shape as the vent holes of the first cover plate or the second cover plate to correspond thereto.

14. The battery module of claim 12, further comprising a venting sheet covering the vent holes between the bus bar assembly and the first cover plate or the second cover plate.
